(19) United States
(12) Patent Application Publication
(10) Pub. No.: US 2024/0364169 A1
(43) Pub. Date: Oct. 31, 2024

(54) STATOR FOR AN ELECTRIC MACHINE, METHOD FOR PRODUCING A STATOR, ELECTRIC MACHINE AND VEHICLE

(71) Applicant: Valeo eAutomotive Germany GmbH, Erlangen (DE)

(72) Inventors: David FOERSTER, Bad Neustadt a.d.Saale (DE); Sebastian BEETZ, Bad Neustadt a.d.Saale (DE); Florian VOLKMUTH, Bad Neustadt a.d.Saale (DE); Christoph ENGLERT, Bad Neustadt a.d.Saale (DE); Christoph WIECZOREK, Bad Neustadt a.d.Saale (DE); Nikolas SEUBERT, Bad Neustadt a.d.Saale (DE)

(73) Assignee: Valeo eAutomotive Germany GmbH, Erlangen (DE)

(21) Appl. No.: 18/682,795

(22) PCT Filed: Jul. 25, 2022
(86) PCT No.: PCT/EP2022/070817

§ 371 Date: Feb. 9, 2024

(30) Foreign Application Priority Data
Aug. 12, 2021 (DE) 10 2021 208 851.1

(51) Int. Cl. H02K 3/38; H02K 15/10; H02K 15/12

(52) U.S. Cl. CPC H02K 3/38; H02K 15/105; H02K 15/12

(57) ABSTRACT

Stator for an electric machine, having a stator core with two axial end sides, a stator winding which extends through the stator core in the axial direction and is formed from a plurality of conductor segments, and covers of a first and a second type. The conductor segments have, at one of the end sides, end sections which are electrically conductively and mechanically connected to one another in pairs to form end section arrangements. The covers of the first type each cover at least two end section arrangements at their free end, and the covers of the second type each cover at least one end section arrangement at their free end.

The present invention relates to a stator for an electric machine, having a stator core with two axial end faces, a stator winding, which extends in the axial direction through the stator core and is formed from a plurality of conductor segments, and covers of a first and second type, wherein the conductor segments have, on one of the end faces, end portions, which are electrically conductively and mechanically connected to one another in pairs to form end portion arrangements, wherein the covers of the first type each cover at least two end portion arrangements at their free end, and wherein the covers of the second type each cover at least one end portion arrangement at their free end.

The invention also relates to a method for producing a stator, to an electric machine and to a vehicle.

DE 10 2004 003 557 A1 discloses a stator for an electrodynamic machine which has a stator core and a stator winding mounted in the stator core. The stator winding is formed by means of base strands. End portions of the base strands are welded. The base strands are designed in such a way that connection portions are provided between the end portions of the base strands. An electrically insulating layer is designed such that it covers each of the connection portions and bridges a pair of the connection portions.

In the case of stators having more complex stator windings, however, difficulties arise in the formation of corresponding covers and in the cooling of the stator.

The invention is based on the object of specifying a, by contrast, improved option for covering end portion arrangements of a stator, the option in particular also being suitable for more complex stator windings.

This object is achieved according to the invention by a stator of the type mentioned at the beginning, in which the covers of the first type and the covers of the second type are adjacent and radially spaced from one another.

The stator according to the invention for an electric machine has a stator core. The stator core has two axial end faces. The stator furthermore has a stator winding. The stator winding extends in the axial direction through the stator core. The stator winding is formed from a plurality of conductor segments. The stator also has covers of a first and second type. The conductor segments have, on one of the end faces, end portions. The end portions are electrically conductively and mechanically connected to one another in pairs to form the end portion arrangements. The covers of the first type each cover at least two end portion arrangements at their free end. The covers of the second type each cover at least one end portion arrangement at their free end. The covers of the first type and the covers of the second type are adjacent and radially spaced from one another.

The invention is based on the consideration of radially spacing the covers of the first and second type from one another. In this way, mechanical stresses can be avoided compared to a cover that extends radially across all of the end portion arrangements. This improves the mechanical stability of the covers. In addition, the spacing between the covers of the first and second type allows a cooling medium, such as air and/or a liquid cooling medium applied by spray cooling, to enter between the covers and drain from there. This improves the coolability of the stator.

The stator core is preferably formed from a multiplicity of individual laminations which are layered axially and/or electrically insulated in relation to one another. A multiplicity of slots which axially extend through the stator core and through which the conductor segments extend may be formed in the stator core.

The stator winding may be in the form of a hair pin winding. In particular, the conductor segments are formed from a metal, for example copper. The conductor segments may have a rectangular or rounded rectangular cross section. At least some of the conductor segments can each comprise two inner portions, which are located within the stator core. In each case one of the end portions can be connected to the inner portions. On the end face opposite the end portions, a respective conductor segment may have a connection portion, which connects the two inner portions electrically conductively to each other. The end portions, the inner portions and the connection portion of a respective conductor segment are preferably formed integrally, in particular from a multiply bent metal rod.

Preferably, the end portions of a respective conductor segment protrude from different slots in the stator core. The end portion arrangements preferably connect two end portions of different conductor segments. The end portions are electrically conductively and mechanically connected to one another in pairs, in particular in an integrally bonded manner, preferably by welding, to form the end portion arrangements.

A predetermined number of inner portions is preferably arranged layered radially within a respective slot. The number is preferably six, eight, ten or twelve.

Preferably, pairs of one of the covers of the first type and one of the covers of the second type are each located at a predetermined position and circumferential direction and radially adjacent and radially spaced from one another.

In a preferred refinement, the covers of the first type and the covers of the second type are adjacent in the radial direction. It may also be provided that the at least two end portion arrangements, which are covered by a respective cover of the first type, are radially adjacent. Alternatively or additionally, it may be provided that the at least two end portion arrangements, which are covered by a respective cover of the first type, are adjacent in the circumferential direction.

It is furthermore preferred, in the case of the stator according to the invention, that the stator winding has a plurality of strands for each phase of the stator, wherein the covers of the first type and the covers of the second type cover end portion arrangements belonging to the same strand. As a result, thermal coupling of end portion arrangements belonging to the same strand can advantageously be achieved by the covers.

In a development of the stator according to the invention, it may be provided that the covers of the first type cover at least three, preferably at least four, end portion arrangements. Alternatively or additionally, it may be provided that the covers of the second type cover at least two, preferably at least three, particularly preferably at least four, end portion arrangements.

In particular, a respective cover of the first type covers at least one end portion arrangement more than a respective cover of the second type. For example, the covers of the second type may cover one end portion arrangement and the covers of the first type may cover two, three, four, five or six end portion arrangements. It is also possible that the covers of the second type cover two end portion arrangements and covers of the first type cover three, four, five or six end portion arrangements. It is also possible that the covers of the second type cover three end portion arrangements and covers of the first type cover four, five or six end portion arrangements.

Alternatively, the covers of the first and second type may in each case cover the same number of end portion arrangements.

If the covers of the second type cover more than one end portion arrangement, it may be provided that the end portion arrangements which are covered by a respective cover of the second type are radially adjacent and/or are adjacent in the circumferential direction.

It may also be provided that the covers of the first type and the covers of the second type are arranged offset from one another in the circumferential direction and connected by diagonal connections. By means of these diagonal connections, thermal coupling of the covers can be produced. In particular if the diagonal connections are formed between covers of the first and second type, said covers covering end portion arrangements belonging to the same strand, a balanced dissipation of heat from the strand can be realized. The diagonal connections are preferably formed integrally with and/or from the same material as the covers of the first and second type that are connected by them. It is preferred here for the stator winding to be chorded.

It may also be provided that the stator furthermore has covers of a third type, which in each case cover at least one end portion arrangement, in particular at least two end portion arrangements, at their free end. In this case, the covers of the third type and the covers of the first type or the second type may be adjacent and radially spaced from one another. The covers of the third type can cover the radially outer or radially inner end portion arrangements. Furthermore, all of the statements regarding the covers of the first and/or second type can be applied to the covers of the third type.

The object on which the invention is based is further achieved by a method for producing a stator, in particular a stator according to the invention, comprising the following steps: providing a stator core with two axial end faces and a stator winding, which extends in the axial direction through the stator core and is formed from a plurality of conductor segments, wherein the conductor segments have, on one of the end faces, end portions, which are electrically conductively and mechanically connected to one another in pairs to form end portion arrangements; and forming electrically insulating covers of the first and second types, wherein the covers of the first type each cover at least two end portion arrangements at their free end, and the covers of the second type each cover at least one end portion arrangement at their free end, such that the covers of the first type and the covers of the second type are adjacent and radially spaced from one another.

In a preferred refinement of the method, it may be provided that the formation comprises the following steps, in particular in the indicated sequence: immersing the end portion arrangements into a liquid insulating material; removing the end portion arrangements from the insulating material; and curing the insulating material. As the insulating material, use may be made of a gel, which in particular is cured over time by irradiation, preferably by ultraviolet radiation, and/or heat treatment and/or by contact with the air.

In a development, the formation may also include the following step: arranging the end portion arrangements in a mask which, for each cover of the first and second type, has an opening, such that, during the immersion, the insulating material surrounds the end portion arrangements within the openings in such a way that the covers are spaced from one another. The mask allows for a targeted formation of the covers along the opening and prevents the formation of accumulations of insulating material between the openings. The mask may be formed by an, in particular circular, metal plate.

It may be provided that the mask is located in the insulating material and the end portion arrangements are inserted into the mask. Alternatively, it may be provided that the mask is arranged on the end portion arrangements and is immersed with the end portion arrangements into the insulating material.

The specific form of the covers may be influenced in various ways: It can be provided, for example, that the end portion arrangements are heated prior to the immersion, and in particular a temperature reached in the process is selected depending on a predetermined layer thickness of the covers. Alternatively or additionally, it may be provided that the end portion arrangements are immersed for a predetermined dwell time, and the dwell time is selected in particular depending on a predetermined extent of the covers in the radial and/or circumferential direction. It is also possible, alternatively or in addition, that the end portion arrangements are heated and/or in particular irradiated with ultraviolet radiation during the curing, wherein in particular a drip time between the removal from the insulating material and starting of the heating and/or irradiation for the curing is selected depending on a predetermined axial extent of the covers along an axial direction facing away from the stator core.

The step of forming the covers of the first and second type may furthermore comprise the formation of covers of a third type, which in each case cover at least one end portion arrangement, in particular at least two end portion arrangements, at their free end, cover, such that the covers of the third type and the covers of the first type or second type are adjacent and radially spaced from one another. The covers of the third type can cover the radially outer or radially inner end portion arrangements. It may be provided that the mask furthermore has a further opening for each cover of the third type.

The object on which the invention is based is furthermore achieved by an electric machine comprising a stator according to the invention or a stator obtained by the method according to the invention; and a rotor which is mounted rotatably with respect to the stator; wherein the electric machine is designed to drive an electrically driveable vehicle.

The electric machine is preferably an, in particular permanently excited, synchronous machine or an asynchronous machine.

The object on which the invention is based is furthermore achieved by a vehicle, comprising an electric machine according to the invention. The vehicle may be a battery-electric vehicle or a hybrid vehicle.

All the statements relating to the stator according to the invention can be analogously applied to the method according to the invention, to the electric machine according to the invention and to the vehicle according to the invention, and therefore the aforementioned advantages can also be achieved with them.

Further advantages and details of the present invention emerge from the exemplary embodiments described below and with reference to the drawings. The latter are schematic illustrations and:

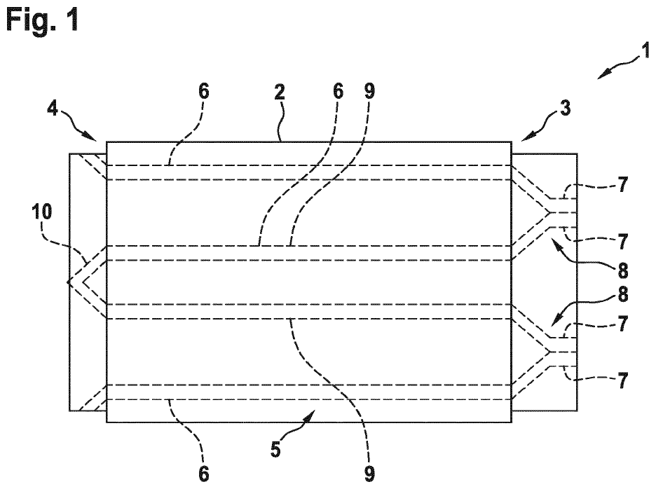

FIG. 1 shows a schematic diagram of a side view of a first exemplary embodiment of the stator according to the invention;

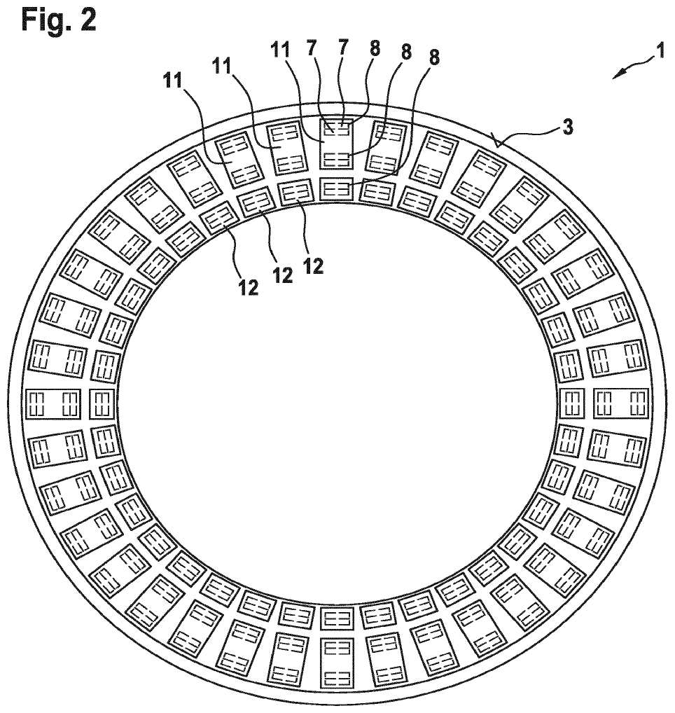

FIG. 2 shows a schematic diagram of a frontal view of the stator according to the first exemplary embodiment;

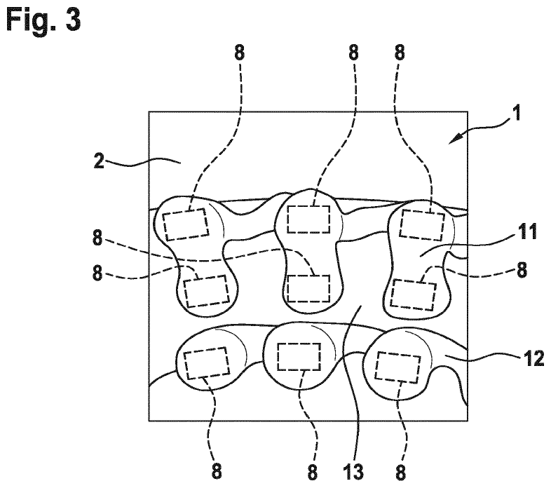

FIG. 3 shows a detailed view of the stator according to the first exemplary embodiment;

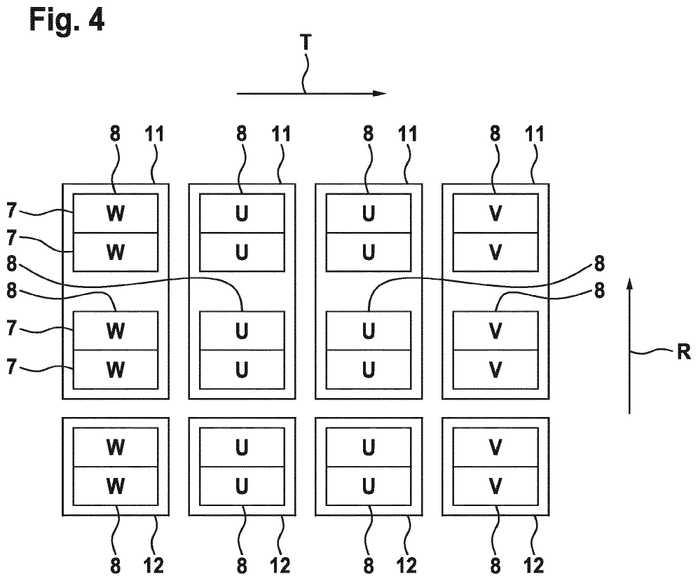

FIG. 4 shows a schematic diagram of the stator according to the first exemplary embodiment in the region of some end portion arrangements;

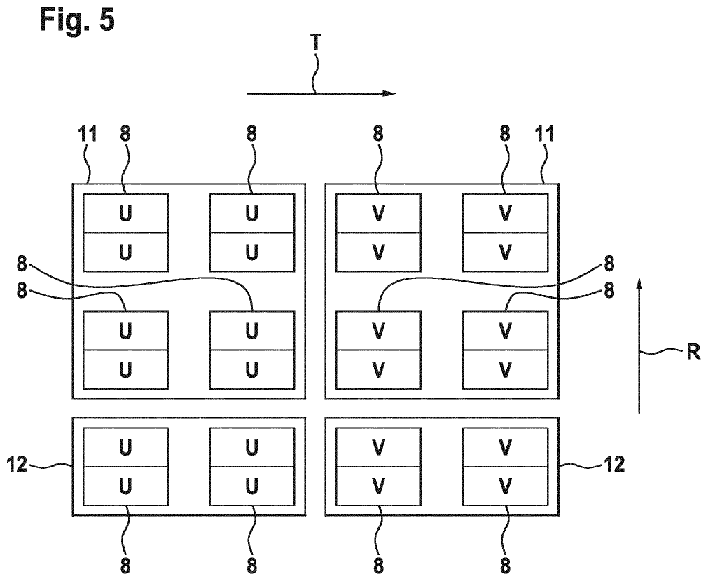

FIGS. 5 to 9 each show a schematic diagram of a further exemplary embodiment of the stator according to the invention in the region of some end portion arrangements;

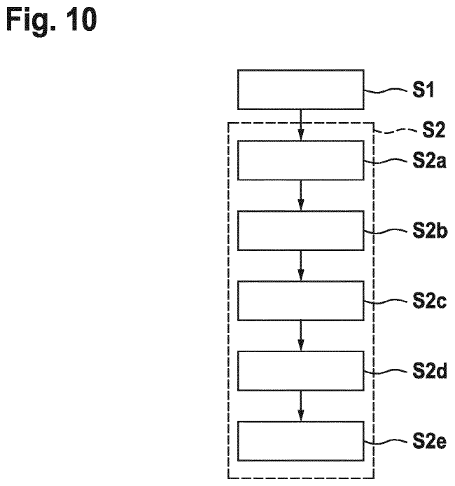

FIG. 10 shows a flow diagram of an exemplary embodiment of the method according to the invention;

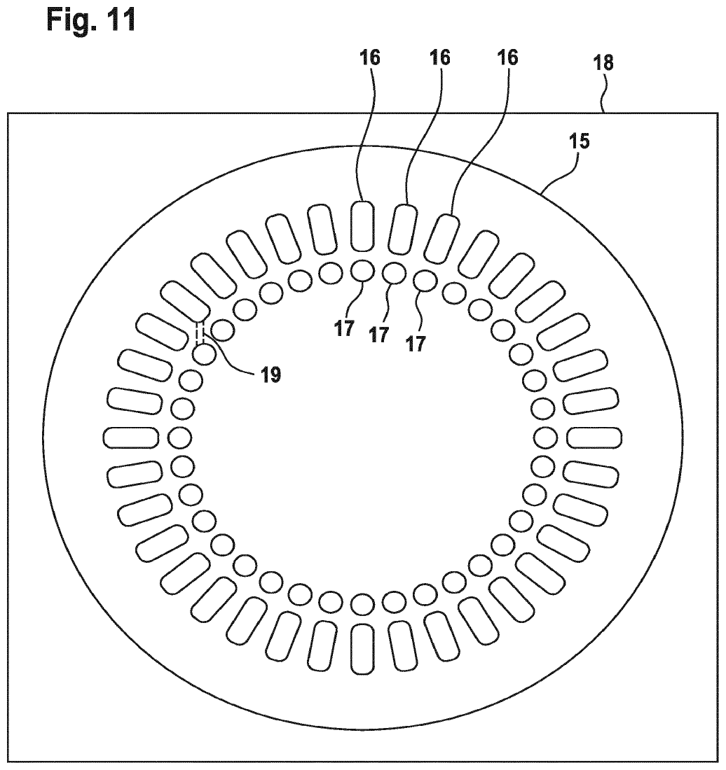

FIG. 11 shows a frontal view of a mask used in the context of an exemplary embodiment of the method according to the invention; and

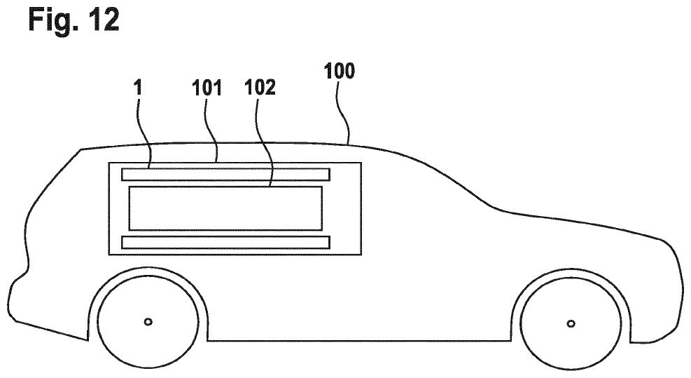

FIG. 12 shows a schematic diagram of an exemplary embodiment of the vehicle according to the invention with an exemplary embodiment of the electric machine according to the invention.

FIG. 1 is a schematic diagram of a side view of a first exemplary embodiment of a stator 1.

The stator 1 has a stator core 2 with two axial end faces 3, 4. A stator winding 5, which is formed from a plurality of conductor segments 6, extends through the stator 1. Three of the conductor segments 6 are shown schematically in FIG. 1. The conductor segments 6 have, on the end face 3, end portions 7, which are electrically conductively and mechanically connected to one another in pairs, for example by welding, to form end portion arrangements 8.

In the present exemplary embodiment, the conductor segments 6e are formed by way of example from multiply bent copper rods having a rectangular or rounded rectangular cross section, such that the stator winding 5 is a hair pin winding. At least some of the conductor segments 6, in addition to two end portions 7, each have two inner portions 9, which are located within the stator core 2 and to which the end portions 7 are connected on the end face 3, and a connection portion 10. The connection portion 10 electrically conductively connects the inner portions 9 on the end face 4 opposite the end portions 7 to one another. The end portions 7, the inner portions 9 and the connection portion 10 of a respective conductor segment 6 are formed integrally here.

FIG. 2 is a schematic diagram of a frontal view of the stator 1 according to the first exemplary embodiment. The end face 3, at which the end portions 7 are connected to one another, is shown.

The stator 1 comprises a plurality of covers of the first type 11 and a plurality of covers of the second type 12. In the present exemplary embodiment, the covers of the first type 11 each cover two end portion arrangements 8 at a free end of the two end portion arrangements 8. The covers of the second type 12 cover an end portion arrangement 8. Generally speaking, the covers of the first type 11 cover at least one end portion arrangement 8 more than the covers of the second type 12.

The stator 1 is distinguished in that the covers of the first type 11 and covers of the second type 12 are adjacent and radially spaced from one another. The end portion arrangements 8 covered by the cover of the first type 11 are also radially adjacent and are located in the same position in the circumferential direction.

By way of example, covers of the first type 11 and end portion arrangements 8 covered by them are provided at thirty-six different positions in the circumferential direction. The number of covers of the second type 12 and the end portion arrangement 8 covered by them corresponds to the number of covers of the first type 11. However, the number of positions may also be greater, for example forty-eight, fifty-four, seventy-two or ninety-six.

As can be gathered from FIG. 2, the covers of the first type 11 are located in the same position in the radial direction. The covers of the second type 12 are located in a different position in the radial direction, said position being further inward than each position at which the covers of the first type 11 are located. Alternatively, the covers of the first type 11 may also be located radially further inward than the covers of the second type 12.

FIG. 3 is a detailed view of the stator 1 according to the first exemplary embodiment in the region of the covers 11, 12.

The covers 11, 12 are formed from an insulating material providing electrical insulation, for example a polymer. Clearly, the covers of the first type 11 form a bridge 13 from the insulating material between the end portion arrangements 8 covered by said covers. The covers 11, 12 axially surround the free ends of the end portion arrangements 8. The covers 11, 12 surround the surfaces of the end portion arrangements 8 further along their longitudinal axis from the free end toward the stator core 2.

FIG. 4 is a schematic diagram of the stator 1 according to the first exemplary embodiment in the region of some directly adjacent end portion arrangements 8. The radial direction is symbolized by an arrow R and the circumferential direction by an arrow T.

The stator winding 5 (see FIG. 1) has a plurality of strands, here by way of example three strands, for each phase U, V, W of the stator 1. The covers of the first type 11 and the covers of the second type 12 cover end portion arrangements 8 which belong to the same strand of the stator 1. The end portion arrangements 8 belonging to a respective strand, or the end portions 7 forming them, are provided for this purpose in FIG. 4 with the designations of the phases U, V, W.

FIG. 5 to FIG. 9 each show a further exemplary embodiment of a stator 1 in the region of some end portion arrangements 8, wherein the type of illustration corresponds to that in FIG. 4 and identical or identically acting components are provided with the same reference signs.

In the second exemplary embodiment according to FIG. 5, the covers of the first type 11 each cover four end portion arrangements 8, which are adjacent radially and in the circumferential direction and belong to the same strand. The radially adjacent covers of the second type 12 each cover two end portion arrangements 8 which are adjacent in the circumferential direction and belong to the same strand.

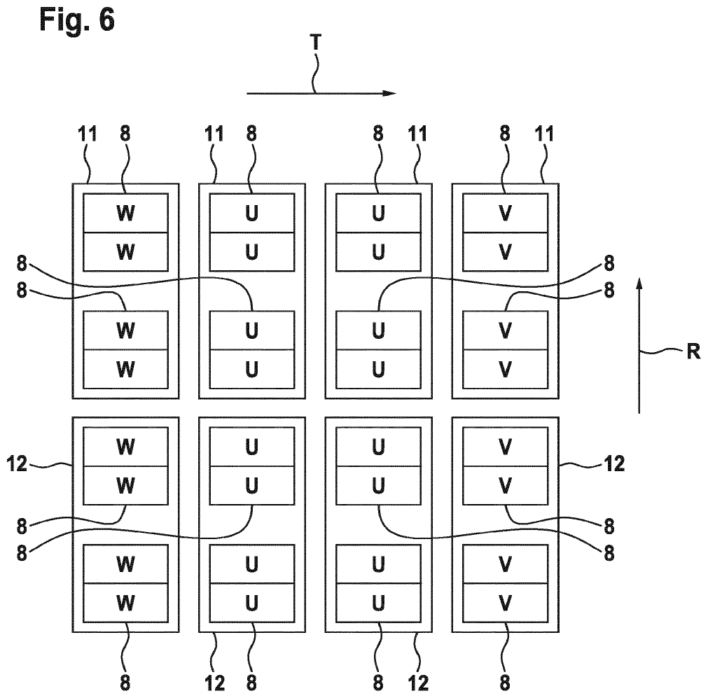

In the third exemplary embodiment according to FIG. 6, the covers of the first type 11 each cover two end portion arrangements 8, which are radially adjacent and belong to the same strand. The radially adjacent covers of the second type 12 each cover two end portion arrangements 8, which are adjacent in the radial direction and belong to the same strand. According to a further exemplary embodiment, the covers of the first type 11 and the covers of the second type 12 can also each cover four end portion arrangements 8 belonging to the same strand and adjacent radially and in the circumferential direction.

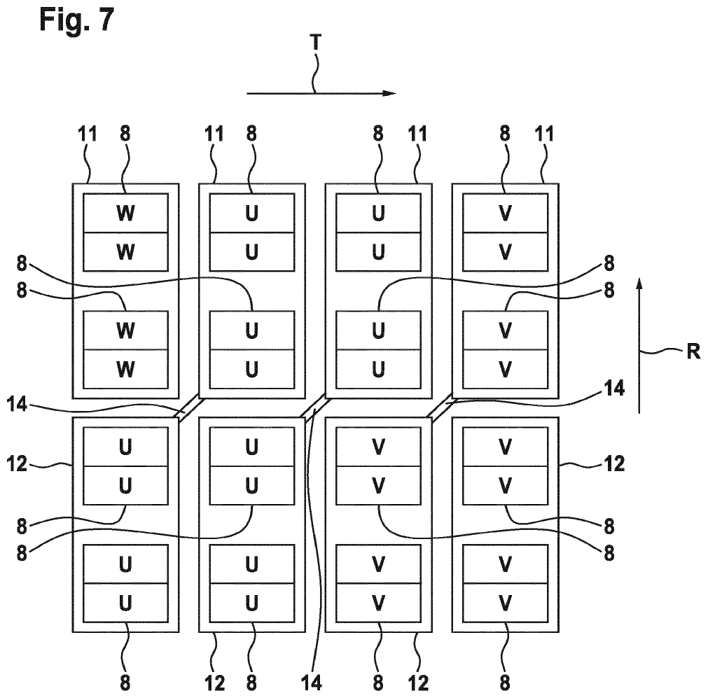

The fourth exemplary embodiment according to FIG. 7 corresponds to the exemplary embodiment according to FIG. 6. The stator 1 has a chorded stator winding 5 here. This means that the affiliation of the end portion arrangements 8 to the individual strands in the case of radially outer end portion arrangements 8 is offset in the circumferential direction relative to radially inner end portion arrangements 8. Covers of the first type 11 and covers of the second type 12, which cover end portion arrangements 8 belonging to the same strand and are offset in the circumferential direction with respect to one another, are connected to one another here by diagonal connections 14 made from the insulating material. This enables corresponding end portion arrangements of the same strand to be thermally coupled to allow uniform cooling. According to a further exemplary embodiment, the covers of the first type 11 and the covers of the second type 12 can also each cover four end portion arrangements 8 belonging to the same strand and adjacent radially and in the circumferential direction.

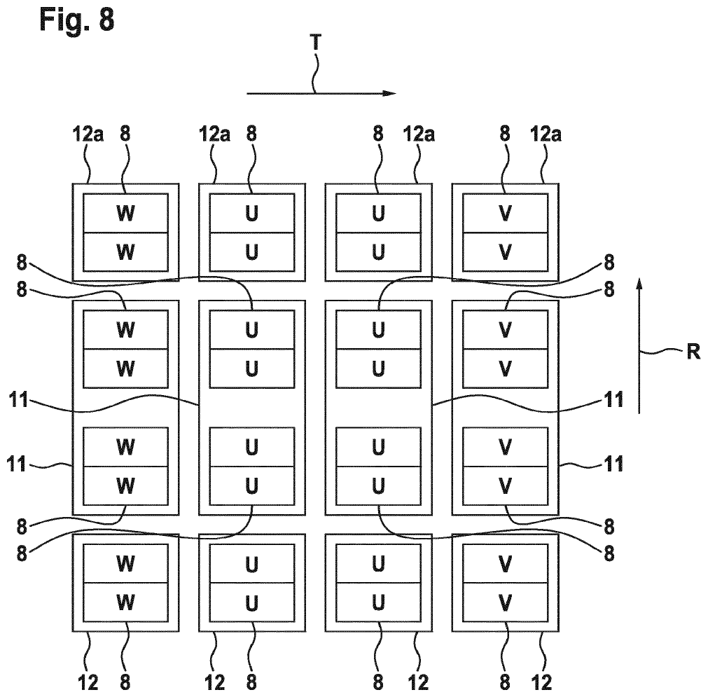

The fifth exemplary embodiment according to FIG. 8 corresponds to the exemplary embodiment according to FIG. 4, wherein covers of the third type 12a, each covering an end portion arrangement 8, are additional provided. The covers of the third type 12a and the covers of the first type 11 are adjacent and radially spaced from one another. The covers of the third type 12a are arranged radially further outward than the covers of the first type 11.

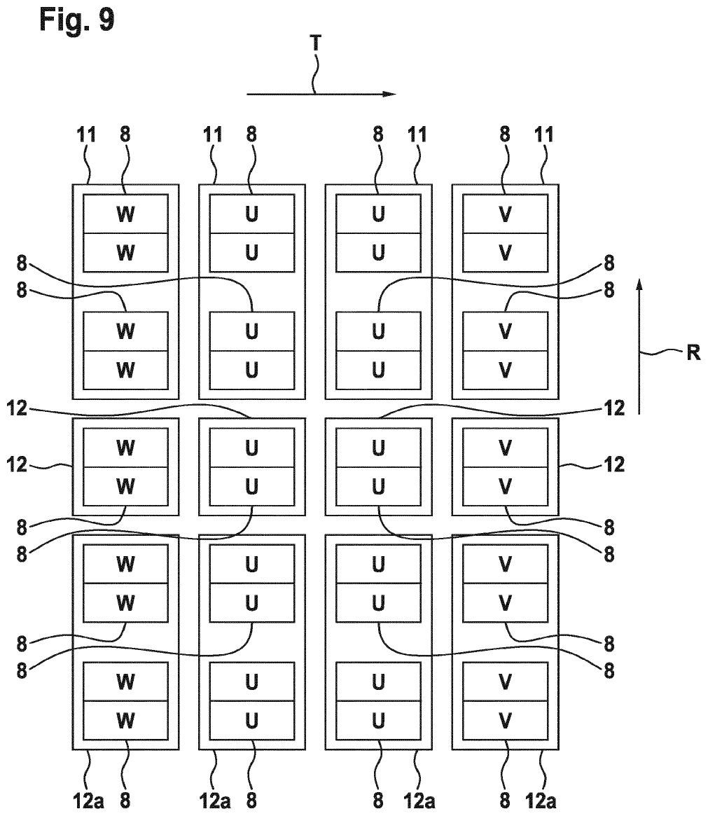

The sixth exemplary embodiment according to FIG. 9 corresponds to the exemplary embodiment according to FIG. 4, wherein covers of the third type 12a, each covering two end portion arrangements 8, are additionally provided. The covers of the third type 12a and the covers of the second type 12 are adjacent and radially spaced from one another. The covers of the third type 12a are arranged radially further inward than the covers of the second type 12.

In the following, exemplary embodiments of a method for producing a stator 1 according to one of the previously described exemplary embodiments will be described. Identical or identically acting components are provided with identical reference signs.

FIG. 10 is a flow diagram of an exemplary embodiment of the production method.

The method comprises a step S1 of providing a stator core 2 with two axial end faces 3, 4 and a stator winding 5, which extends in the axial direction through the stator core 2 and is formed from a plurality of conductor segments 6, wherein the conductor segments 6 have, on one of the end faces 3, end portions 7, which are electrically conductively and mechanically connected, for example welded, to one another in pairs to form end portion arrangements 8.

The method further comprises a subsequent step S2 of forming electrically insulating covers of the first and second types 11, 12, wherein the covers of the first type 11 each cover at least two end portion arrangements 8 at a free end of the at least two end portion arrangements 8 and the covers of the second type 12 each cover at least one end portion arrangement 8 at a free end of the at least one end portion arrangement 8, such that the covers of the first type 11 and the covers of the second type 12 are adjacent and radially spaced from one another.

Step S2 comprises the following steps S2a to S2e:

In a step S2a, the end portion arrangements 8 are heated, wherein a temperature reached in this case is selected depending on a predetermined layer thickness of the covers 11, 12.

In a step S2b, the end portion arrangements 8 are immersed into a liquid insulating material.

The step S2 further comprises a step S2c of arranging the end portion arrangements 8 in a mask 15, which is shown in FIG. 11 in a frontal view. The mask 15 has an opening 16 for each cover of the first type 11 and an opening 17 for each cover of the second type 12. The mask 15 is located in the insulating material, which is placed into a immersion basin 18. The arrangement is undertaken in such a way that, during the immersion, the insulating material surrounds the end portion arrangements 8 within the openings 16, 17 in such a way that the covers are spaced from one another.

The mask 15 is formed here according to the first exemplary embodiment of the stator 1. The openings 16, 17 are shaped differently in accordance with the shape of the covers 11, 12 in order to form the stator 1 according to the other exemplary embodiments. For the formation of the diagonal connections 14 (see FIG. 7), the mask 15 can have connection openings 19, indicated in FIG. 11, between the openings 16 and the openings 17.

The end portion arrangements 8 are immersed for a predetermined dwell time, which is selected in the radial and/or peripheral direction depending on a predetermined extent of the covers 11, 12.

The step S2 further comprises a step S2d of removing the end portion arrangements 8 from the insulating material.

The step S2 further comprises a step S2e of curing the insulating material. During the curing, end portion arrangements 8 are heated, wherein a drip time between the removal from the insulating material and starting of the heating is selected depending on a predetermined axial extent of the covers 11, 12 along an axial direction opposed to the stator core 2.

According to a further exemplary embodiment of the production method, the mask 15 is arranged on the end portion arrangements 8 and immersed with the end portion arrangements 8 into the insulating material. To this extent, the steps S2b and S2c are interchanged here.

FIG. 12 shows a schematic diagram of an exemplary embodiment of a vehicle 100 having an exemplary embodiment of an electric machine 101.

The electric machine 101 has a stator 1 according to one of the exemplary embodiments described above or a stator 1 obtained by one of the exemplary embodiments of the production method. In addition, the electric machine 101 has a rotor mounted rotatably within the stator. The electric machine 101 is a permanently excited synchronous machine or an asynchronous machine and is designed for driving the vehicle 100. The vehicle 100 is a battery-electric vehicle (BEV) or a hybrid vehicle.

1. A stator for an electric machine, having a stator core with two axial end faces, a stator winding, which extends in the axial direction through the stator core and is formed from a plurality of conductor segments, and covers of a first and second type, wherein
the conductor segments have, on one of the end faces, end portions, which are electrically conductively and mechanically connected to one another in pairs to form end portion arrangements, wherein
the covers of the first type each cover at least two end portion arrangements at their free end, and wherein
the covers of the second type each cover at least one end portion arrangement at their free end,
wherein
the covers of the first type and the covers of the second type are adjacent and radially spaced from one another.

2. The stator as claimed in claim 1, wherein
the covers of the first type and the covers of the second type are adjacent in the radial direction, and the at least two end portion arrangements, which are covered by a respective cover of the first type,
are radially adjacent and/or
are adjacent in the circumferential direction.

3. The stator as claimed in claim 1, wherein
the stator winding has a plurality of strands for each phase of the stator, wherein the covers of the first type and the covers of the second type cover end portion arrangements belonging to the same strand.

4. The stator as claimed in claim 1, wherein
the covers of the first type cover at least three, preferably at least four, end portion arrangements.

5. The stator as claimed in claim 1, wherein
the covers of the second type cover at least two, preferably at least three, particularly preferably at least four, end portion arrangements.

6. The stator as claimed in claim 5, wherein
the end portion arrangements, which are covered by a respective cover of the second type,
are radially adjacent and/or are adjacent in the circumferential direction.

7. The stator as claimed in claim 1, wherein
a respective cover of the first type covers at least one end portion arrangement more than a respective cover of the second type.

8. The stator as claimed in claim 1, wherein
the covers of the first type and the covers of the second type are arranged offset from one another in the circumferential direction and connected by diagonal connections.

9. A method for producing a stator, in particular a stator as claimed in claim 1, comprising the following steps:
providing a stator core with two axial end faces and a stator winding, which extends in the axial direction through the stator core and is formed from a plurality of conductor segments, wherein the conductor segments have, on one of the end faces, end portions, which are electrically conductively and mechanically connected to one another in pairs to form end portion arrangements; and
forming electrically insulating covers of the first and second types, wherein the covers of the first type each cover at least two end portion arrangements at their free end, and the covers of the second type each cover at least one end portion arrangement at their free end, such that the covers of the first type and the covers of the second type are adjacent and radially spaced from one another.

10. The method as claimed in claim 9, wherein
the formation comprises the following steps in the indicated sequence:
immersing the end portion arrangements into a liquid insulating material;
removing the end portion arrangements from the insulating material; and
curing the insulating material.

11. The method as claimed in claim 10, wherein the formation further comprises the following step:
arranging the end portion arrangements in a mask which, for each cover of the first and second type, has an opening, such that, during the immersion, the insulating material surrounds the end portion arrangements within the openings in such a way that the covers are spaced from one another.

12. The method as claimed in claim 11, wherein
the mask is located in the insulating material and the end portion arrangements are inserted into the mask, or
the mask is arranged on the end portion arrangements and is immersed with the end portion arrangements into the insulating material.

13. The method as claimed in claim 10, wherein
the end portion arrangements are heated prior to the immersion, and in particular a temperature reached in the process is selected depending on a predetermined layer thickness of the covers, and/or
the end portion arrangements are immersed for a predetermined dwell time, and the dwell time is selected in particular depending on a predetermined extent of the covers in the radial and/or circumferential direction, and/or
the end portion arrangements are heated and/or irradiated during the curing, wherein in particular a drip time between the removal from the insulating material and starting of the heating and/or irradiation for the curing is selected depending on a predetermined axial extent of the covers along an axial direction facing away from the stator core.

14. An electric machine, comprising
a stator as claimed in claim 1; and
a rotor mounted rotatably with respect to the stator;
wherein the electric machine is designed to drive an electrically driveable vehicle.

15. A vehicle, comprising an electric machine as claimed in claim 14.

16. The stator as claimed in claim 2, wherein
the stator winding has a plurality of strands for each phase of the stator, wherein the covers of the first type and the covers of the second type cover end portion arrangements belonging to the same strand.

17. The stator as claimed in claim 2, wherein
the covers of the first type cover at least three, preferably at least four, end portion arrangements.

18. The stator as claimed in claim 2, wherein
the covers of the second type cover at least two, preferably at least three, particularly preferably at least four, end portion arrangements.

19. The stator as claimed in claim 2, wherein
a respective cover of the first type covers at least one end portion arrangement more than a respective cover of the second type.

20. The stator as claimed in claim 2, wherein
the covers of the first type and the covers of the second type are arranged offset from one another in the circumferential direction and connected by diagonal connections.
